(19) United States
(12) Patent Application Publication
(10) Pub. No.: US 2013/0262849 A1
(43) Pub. Date: Oct. 3, 2013

(54) AUTOMATIC RECONFIGURATION OF INITIALIZATION FIRMWARE IN A COMPUTER SYSTEM

(71) Applicants: Bheeshmar Redheendran, Austin, TX (US); Timothy Louis Jensen, Austin, TX (US)

(72) Inventors: Bheeshmar Redheendran, Austin, TX (US); Timothy Louis Jensen, Austin, TX (US)

(21) Appl. No.: 13/434,110

(22) Filed: Mar. 29, 2012

(51) Int. Cl. G06F 9/00; G06F 15/177

(52) U.S. Cl. 713/100

(57) ABSTRACT

A system and method for automatically reconfiguring the initialization firmware (e.g., BIOS firmware or UEFI firmware) of a computer system are described. The computer system may execute an IFW (initialization firmware) configuration software tool to receive input requesting to change the configuration of the initialization firmware, and to change the configuration as requested by the input. The IFW configuration software tool may execute to change the initialization firmware after a boot procedure of the computer system has completed, and while an operating system of the computer system is executing. The changes may take effect the next time the computer system is booted.

### BACKGROUND OF THE INVENTION

1. Field of the Invention

This invention relates to the field of computer systems, and more particularly, to a system and method for automatically reconfiguring the initialization firmware of a computer system.

2. Description of the Related Art

A boot procedure (also known as booting up) is the initial set of operations that a computer system performs when electrical power is switched on. Initialization firmware includes program instructions executed by the computer system during the boot procedure. Examples of interfaces to initialization firmware include BIOS (Basic Input/Output System) interfaces and UEFI (Unified Extensible Firmware Interface) interfaces. The initialization firmware is stored in non-volatile memory of the computer system, e.g., in some form of ROM (Read-Only Memory) or flash memory.

The initialization firmware performs functions during the boot procedure to enable the computer system to initialize and begin functioning, such as loading device drivers, performing a self-test to check that the devices used in the computer system are functioning properly, and loading the operating system. The initialization firmware may also include program instructions that executes after the boot procedure has completed, e.g., low-level software routines called by the operating system to interface with the keyboard, monitor, bus ports, and other devices of the computer system.

The initialization firmware typically has various properties or settings that can be changed by a user through a user interface. The user interface is typically accessed in response to the user pressing a particular key or combination of keys on the keyboard during the boot procedure. The user interface may enable the user to enable or disable system devices, select options for the system devices, select which devices are eligible to be boot devices and/or set the boot order of these devices, select power management options, etc. Once the user has made his changes, the non-volatile memory that stores the initialization firmware may be updated to indicate the changes, and the boot procedure may continue.

Computer systems generally do not enable the initialization firmware to be automatically changed. Instead, the user may be required to manually change the initialization firmware through a user interface as described above. Computer systems also generally do not enable the initialization firmware to be changed after the boot procedure has completed or after the operating system begins executing.

### SUMMARY

Various embodiments of a system and method for automatically reconfiguring the initialization firmware of a computer system are described. In some embodiments the initialization firmware may include BIOS (Basic Input/Output System) firmware. In other embodiments the initialization firmware may include UEFI (Unified Extensible Firmware Interface) firmware.

The system and method may operate to receive input requesting to change the configuration of the initialization firmware after a boot procedure of the computer system has completed, and while an operating system of the computer system is executing. The initialization firmware may include information stored in non-volatile memory of the computer system. The system and method may further operate to automatically change the configuration of the initialization firmware as requested by the input. Automatically changing the configuration of the initialization firmware may include automatically changing the information stored in the non-volatile memory.

In some embodiments the input request may indicate one or more properties of the initialization firmware and a corresponding value for each of the one or more properties. Automatically changing the configuration of the initialization firmware may include configuring each of the one or more properties based on the corresponding value.

In some embodiments the system and method may operate to automatically generate configuration information based on the input, and to apply the configuration information to the initialization firmware. Applying the configuration information to the initialization firmware may configure each of the one or more properties based on the corresponding value.

In some embodiments, generating the configuration information may include storing information in a memory buffer. Each of the one or more properties may correspond to a memory location at a respective offset of the memory buffer. Storing the information in the memory buffer may include setting the memory location corresponding to each respective property to the value corresponding to the property.

In some embodiments the configuration information may be applied to the initialization firmware by passing the memory buffer to a software routine implemented by the initialization firmware. In some embodiments the software routine may include a SMI (System Management Interrupt) implemented by the initialization firmware.

In some embodiments, generating the configuration information may include generating a set of I/O (input/output) operations to perform on the non-volatile memory. Applying the configuration information to the initialization firmware may include performing each I/O operation in the generated set of I/O operations.

In some embodiments of the system, an administration computer may be coupled to a plurality of computers via a network. Each computer of the plurality of computers may include non-volatile memory storing initialization firmware information. The administration computer may be configured to transmit to each respective computer of the plurality of computers input requesting to change the initialization firmware information stored in the non-volatile memory of the respective computer. Each respective computer of the plurality of computers may be configured to receive the input from the administration computer after the respective computer has completed a boot procedure, and automatically change the initialization firmware information stored in the non-volatile memory of the respective computer as requested by the input.

In some embodiments the plurality of computers coupled to the administration computer may be server computers that implement a service cloud providing computing services.

In some embodiments the plurality of computers coupled to the administration computer may be computers under test in an automated testing procedure.

Further embodiments may include a computer-accessible storage medium storing program instructions executable by one or more processors to implement various aspects of the method described above.

### BRIEF DESCRIPTION OF THE DRAWINGS

A better understanding can be obtained when the following detailed description is considered in conjunction with the following drawings, in which:

FIG. 1 illustrates an example of a computer system that utilizes initialization firmware;

FIG. 2 illustrates an example of a service cloud including a plurality of server computers;

FIG. 3 illustrates components of one embodiment of a computer system configured to execute an IFW (initialization firmware) configuration software tool;

FIG. 4 is a flowchart diagram illustrating one embodiment of a method implemented by the IFW configuration software tool;

FIG. 5 illustrates a portion of mapping information used by the IFW configuration software tool according to one embodiment;

FIG. 6 illustrates portions of a memory buffer in which current initialization firmware settings are stored;

FIG. 7 illustrates portions of the memory buffer in which modified initialization firmware settings are stored;

FIG. 8 illustrates an architecture of the IFW configuration software tool according to some embodiments; and

FIG. 9 is a block diagram illustrating a computer accessible storage medium.

While the invention is susceptible to various modifications and alternative forms, specific embodiments are shown by way of example in the drawings and are herein described in detail. It should be understood, however, that drawings and detailed description thereto are not intended to limit the invention to the particular form disclosed, but on the contrary, the invention is to cover all modifications, equivalents and alternatives falling within the spirit and scope of the present invention as defined by the appended claims.

### DETAILED DESCRIPTION

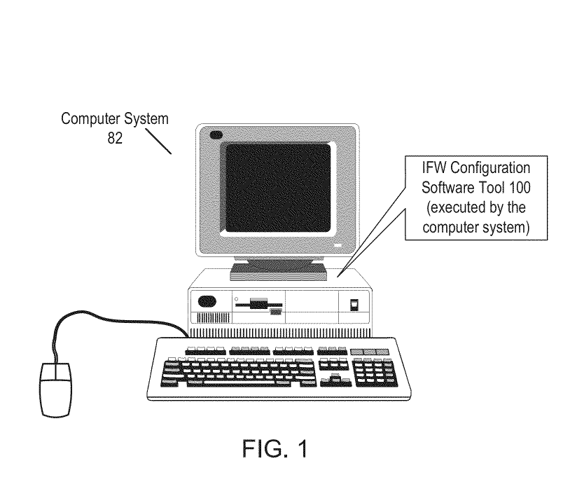

FIG. 1 illustrates an example of a computer system 82 that utilizes initialization firmware. In various embodiments the initialization firmware may be any kind of firmware stored in non-volatile memory of the computer system 82 that is executed by the computer system 82 during a boot procedure and performs at least the function of initializing devices used in the computer system 82. Examples of the initialization firmware that can be used by the computer system 82 include BIOS firmware, which refers to firmware that uses a standard BIOS (Basic Input/Output System) interface; and UEFI firmware, which refers to firmware that uses a standard UEFI (Unified Extensible Firmware Interface) interface.

The computer system 82 may be any kind of computer system that executes initialization firmware during a boot procedure, such as a personal computer (PC) (e.g., a desktop computer or laptop computer), tablet computer, workstation, network appliance, etc. According to embodiments of the present system and method, the computer system 82 may be configured with an IFW (initialization firmware) configuration software tool 100. The IFW configuration software tool 100 may be executable by the computer system 82 to change various properties or settings of the initialization firmware, e.g., by changing the BIOS firmware or UEFI firmware stored in non-volatile memory of the computer system 82. More particularly, the IFW configuration software tool 100 may execute to receive an input request to change the configuration of the initialization firmware, and to change the configuration of the initialization firmware in response to the input request.

Unlike the conventional manner of changing the BIOS firmware through a user interface during the boot procedure, the IFW configuration software tool 100 may execute to change the BIOS firmware or other initialization firmware after the boot procedure has completed. During the boot procedure, the computer system 82 may execute the initialization firmware to initialize the devices of the computer system 82, load the operating system, and perform other functions to initialize the computer system 82. After the boot procedure has completed and while the operating system is executing, the IFW configuration software tool 100 may be loaded into memory of the computer system 82 and executed by one or more processors of the computer system 82 to receive input requesting one or more changes to the initialization firmware and to change the initialization firmware stored in the non-volatile memory to implement the requested changes. The changes to the initialization firmware may not take effect immediately, but instead may take effect the next time the computer system 82 is booted, e.g., when the initialization firmware information is read from the non-volatile memory during the boot procedure.

Also unlike the conventional manner of changing the BIOS firmware in response to interactive user input specifying the desired changes, embodiments of the IFW configuration software tool 100 described herein may be operable to change the BIOS firmware or other initialization firmware automatically, e.g., without a user interactively or manually specifying the changes. For example, in some embodiments the IFW configuration software tool 100 may receive the input specifying the initialization firmware changes through an input file, and may then automatically change the initialization firmware configuration as requested by the input. Also, in some embodiments the IFW configuration software tool 100 may receive the input specifying the initialization firmware changes via a network from a remote computer system.

The ability to perform initialization firmware changes at times other than during the boot procedure and without requiring interactive user input may enhance the speed and ease of re-configuring the initialization firmware. This may be useful in various applications that require the initialization firmware of a computer system to be changed, such as system administration and automated testing.

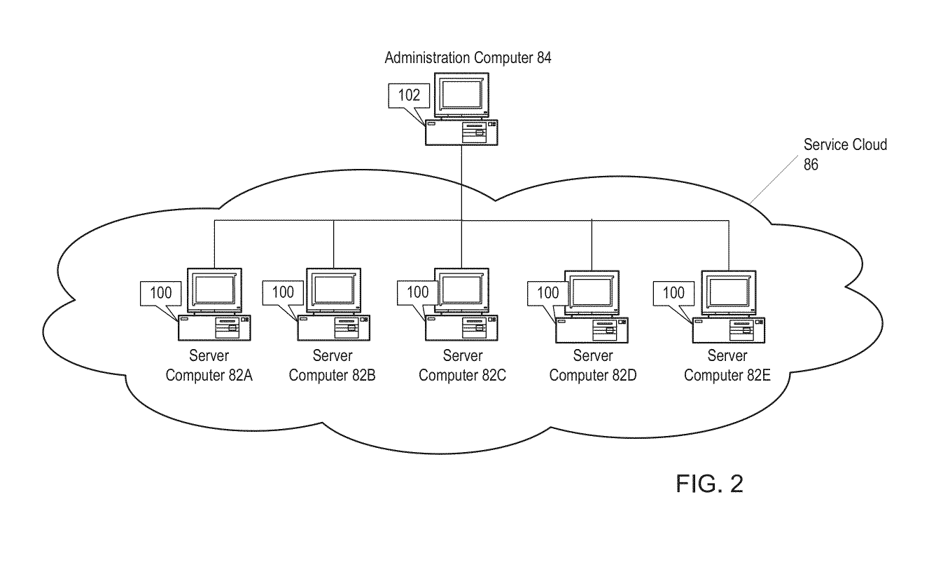

The ability to remotely control the initialization firmware changes via a network may be particularly useful for applications that require the initialization firmware of multiple computer systems to be changed. As one example, embodiments of the system and method may be used for cloud computing provisioning. FIG. 2 illustrates an example of a service cloud 86 including a plurality of server computers 82A-82E. The server computers 82A-82E may provide computing services for other client computers according to a cloud computing model. An administration computer system 84 may be coupled to the server computers through a network. The network may include any type of network or combination of networks, such as any type or combination of local area network (LAN), a wide area network (WAN), wireless networks, an Intranet, the Internet, etc. The administration computer 84 may transmit requested initialization firmware changes to each of the server computers (or to a subset of the server computers) in the service cloud. Each respective server computer may execute a respective instance of the IFW configuration software tool 100 which receives the request transmitted from the administration computer 84 and automatically reconfigures the initialization firmware of the respective server computer in response to the request. This may enable an administrator to remotely reconfigure the initialization firmware of various server computers that provide the computing services for the service cloud 86.

The administration computer 84 may execute administration software 102 that transmits the initialization firmware configuration request to the server computers in the service cloud. In some embodiments the administration software 102 may provide a graphical user interface that enables the administrator to specify the desired initialization firmware changes, select which server computers to transmit the initialization firmware changes to, etc.

Similar architectures may be used for other types of applications that require the initialization firmware of multiple computer systems to be changed. As one example, in a factory that produces computers, multiple computers may be tested in an automated testing application. Each of the computers under test may need to be tested with multiple initialization firmware configurations. An administration computer may transmit initialization firmware change requests to each computer under test to cause the initialization firmware of the respective computer to be automatically reconfigured during the testing procedure. As another example, in an organization in which different users use different computers, an administrator may use an administration computer to transmit initialization firmware change requests to each user computer in order to change the initialization firmware of the user computers, e.g., to comply with system requirements of the organization.

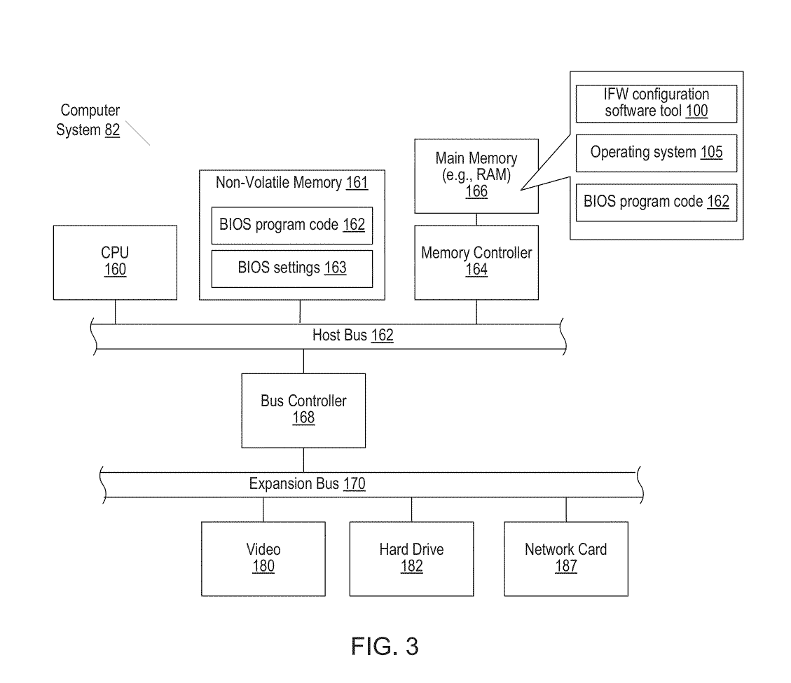

FIG. 3 illustrates components of one embodiment of a computer system 82 configured to execute the IFW configuration software tool 100. In general the computer system 82 may be any kind of personal computer system (PC), workstation, network appliance, laptop computer, tablet computer, or other computing device that uses initialization firmware. In the illustrated embodiment, the initialization firmware of the computer system 82 includes BIOS firmware, but in other embodiments the initialization firmware may include UEFI firmware or initialization firmware implemented according to other initialization firmware interfaces. The computer system 82 may have any configuration or architecture, and FIG. 3 illustrates an example of one embodiment. Elements of a computer not necessary to understand the present description have been omitted for simplicity.

The computer system 82 may include at least one central processing unit (CPU) or processor 160 which is coupled to a processor or host bus 162. The CPU 160 may be any of various types. For example, in some embodiments, the processor 160 may be compatible with the x86 architecture. Also, in some embodiments the computer system 82 may include multiple processors 160.

The computer system 82 may also include non-volatile memory 161 that stores BIOS information, including BIOS program code 162 and BIOS settings 163. The BIOS program code 162 may include executable code to implement functions performed during the boot procedure to enable the computer system 82 to initialize and begin functioning, as well as low-level software routines that enable the operating system to interface with the keyboard, monitor, bus ports, and other devices of the computer system. The BIOS program code 162 may also include one or more software routines, e.g., SMI (System Management Interrupt) handlers, called by the IFW configuration software tool 100 in some embodiments, as described below.

The BIOS settings 163 include information that affects the operation of the BIOS program code 162, e.g., affects how the BIOS program code 162 configures various components or devices of the computer system 82. The IFW configuration software tool 100 may be executable to receive input requesting changes to one or more of the BIOS settings 163 and to modify the BIOS settings 163 accordingly. Examples of BIOS settings that may be changed by the IFW configuration software tool 100 are discussed below.

In various embodiments the BIOS program code 162 and the BIOS settings 163 may be stored on one or more non-volatile memory devices of any type. Examples of non-volatile memory devices that can store the BIOS information include various forms of ROM (Read-Only Memory) or flash memory, e.g., SEEPROM, CMOS, etc. In some embodiments the BIOS program code 162 and/or the BIOS settings 163 may be stored on multiple non-volatile memory devices, e.g., multiple chips. Although the BIOS program code 162 and the BIOS settings 163 are shown as separate blocks in FIG. 3, in some embodiments these components may not be separated from each other in the non-volatile memory 161. For example, the BIOS settings 163 may be embedded as data within the BIOS program code 162 in some embodiments.

The computer system 82 may also include main memory 166, which stores software executed by the processor 160. In some embodiments the main memory 166 may include one or more forms of RAM (random access memory) such as dynamic RAM (DRAM) or synchronous DRAM (SDRAM). In other embodiments, the main memory 166 may include any other type of memory configured to store program instructions executed by the processor 160.

When the computer system 82 is powered on, the BIOS program code 162 may be loaded from the non-volatile memory 161 into the main memory 166 for execution by the processor 160. The BIOS program code 162 may configure other devices (e.g., the hard drive 182, video device 180, etc.) as specified by the BIOS settings 163, as well as loading the operating system 105 into the main memory 166 and performing other functions to initialize the computer system 82. After the boot procedure has completed, the IFW configuration software tool 100 may be loaded into the main memory 166 and may be executed by the processor 160 to reconfigure the BIOS settings 163 as described herein.

The memory controller 164 may be configured to control the main memory 166. The processor 160 and memory controller 164 may be coupled to a host bus 162. The host bus 162 may be coupled to an expansion or input/output bus 170 by means of a bus controller 168 or bus bridge logic. In some embodiments the expansion bus 170 may be a PCI (Peripheral Component Interconnect) expansion bus, although other bus types can be used. Various devices may be coupled to the expansion or input/output bus 170, such as a video display subsystem 180 which sends video signals to a display device, as well as one or more hard disk drives 182 or other storage devices. The computer system 82 may also include a network card or device 187 that enables the computer system 82 to send and receive information over a network.

After the boot procedure of the computer system 82 has completed, the IFW configuration software tool 100 may execute to receive input requesting to change one or more of the BIOS settings 163, and to automatically change the specified BIOS setting(s), e.g., by changing data in the non-volatile memory 161 which stores the BIOS settings 163 and/or changing the BIOS program code 162. Changing the BIOS settings may reconfigure the BIOS such that the changed settings take effect the next time the computer system 82 is booted.

The IFW configuration software tool 100 may reconfigure the BIOS by automatically generating configuration information based on the input, and applying the configuration information to the BIOS. Applying the configuration information to the BIOS may reconfigure one or more of the BIOS settings as requested by the input.

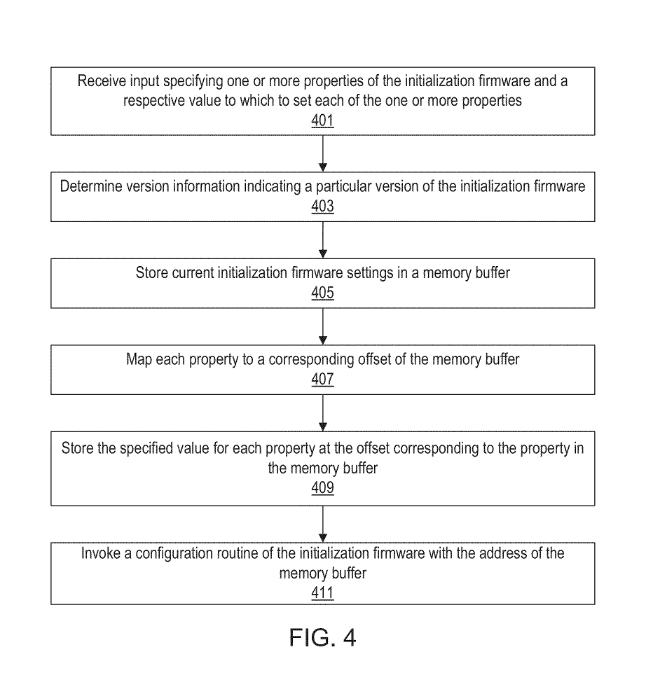

In various embodiments the IFW configuration software tool 100 may use any of various techniques to automatically generate and apply configuration information in order to reconfigure the initialization firmware of the computer system 82. FIG. 4 is a flowchart diagram illustrating one embodiment of a method implemented by the IFW configuration software tool 100 to perform this functionality.

As indicated in block 401, the IFW configuration software tool 100 may receive input specifying one or more properties of the initialization firmware and a corresponding value to which to set each of the one or more properties. The IFW configuration software tool 100 may receive the input in various ways, such as by reading the input from a file stored on the computer system 82, or receiving the input from a remote computer system.

The IFW configuration software tool 100 may be configured to receive and act upon input to change any of various types of properties that are configurable in the initialization firmware, such as any of the various properties that are configurable using the conventional method in which a user interactively configures the BIOS firmware during the boot procedure.

Examples of properties and corresponding values that may be specified by the user input include properties related to disk drives of the computer system. For example, in some embodiments the computer system may use BIOS firmware that has a property controlling the configuration of floppy drives. Possible values corresponding to this property may include an “Off” value indicating that all floppy drives are disabled, a “USB” value indicating that USB floppy drives are enabled, and an “Internal” value indicating that the integrated floppy drive is enabled. As another example, the BIOS firmware may have a property that controls the configuration of an integrated NIC (network interface card), with possible values of “On” indicating that the integrated NIC is enabled, and “Off” indicating that the integrated NIC is disabled. The BIOS firmware may also have various properties related to system power management. For example, the BIOS firmware may have a property that controls how the computer system responds when AC power is restored after being cut off Possible values for this property may include an “Off” value indicating that the computer system should stay off, an “On” value indicating that the computer system should turn back on, and a “Last” value indicating that the computer system should turn back on and return to the previous state it was in before the AC power was lost. These are just a few examples of the types of properties and values that can be set by the IFW configuration software tool 100.

Different computer systems may use different initialization firmware versions. The IFW configuration software tool 100 may be constructed so that it is able to reconfigure a plurality of different initialization firmware versions. As indicated in block 403, the IFW configuration software tool 100 may determine version information indicating the particular version of the initialization firmware that is used by the computer system on which the IFW configuration software tool 100 is currently executing. For example, in an embodiment in which the initialization firmware includes BIOS firmware, the IFW configuration software tool 100 may determine the BIOS version by querying the BIOS program code 162 or the operating system 105 for this information, or by reading the version information from the non-volatile memory 161 or from a file or registry.

In the conventional method in which a user interactively configures the BIOS during the boot procedure, different BIOS versions often display different user interfaces. For example, properties on two different BIOS versions may have the same purpose and the same set of possible values, but the words used to name or describe the properties and values may be different in the user interface for each BIOS that is shown to the user during the boot procedure. The user interface of the BIOS may also be set to display different languages.

The input provided to the IFW configuration software tool 100 may be standardized so that the same input will cause similar changes to different initialization firmware versions. For example, if a given property has the same meaning or purpose on different BIOS versions, the property may be assigned an identifier or token that refers to the property across all the different BIOS versions that use or support the property. This identifier or token may be specified in the input provided to the IFW configuration software tool 100 in block 401. Identifiers may also be assigned to the possible values for each property. In some embodiments the identifiers for the properties and values may be text strings. For example, the BIOS property mentioned above that controls the configuration of floppy drives may be assigned an identifier of “Floppy”, and the possible values for the property may be assigned identifiers of “Off”, “USB”, and “Internal”. In other embodiments the identifiers for the properties and values may be integers or other kinds of tokens. Thus for example, to reconfigure the BIOS to disable all floppy drives, the input may specify the identifier of the appropriate property (e.g., “Floppy”) and the identifier of the appropriate value (e.g., “Off”).

The IFW configuration software tool 100 may be configured with mapping information that is used to translate the properties and values specified by the input into configuration information to be applied to the initialization firmware. Blocks 405-409 illustrates one embodiment of generating the configuration information. As indicated in block 405, the IFW configuration software tool 100 may store the current initialization firmware settings in a memory buffer. For example, the IFW configuration software tool 100 may allocate a memory buffer (e.g., block of memory) in the main memory 166 of the computer system 82 and then fill the memory buffer with information indicating the current initialization firmware settings. In some embodiments the IFW configuration software tool 100 may invoke a software routine implemented by the initialization firmware, and the software routine may execute to store the current initialization firmware settings in the memory buffer. For example, in some embodiments the initialization firmware may include BIOS firmware, and the IFW configuration software tool 100 may invoke an SMI (System Management Interrupt) handler implemented by the BIOS program code 162, which may execute to store the current BIOS settings in the memory buffer.

In some embodiments, each initialization firmware property may correspond to a particular offset of the memory buffer. The value to which each property is currently set may be stored in the memory buffer at the offset corresponding to the property. In order to change a given property to a new value, the IFW configuration software tool 100 may map the property to the offset in the memory buffer that corresponds to the property in order to determine the location in the memory buffer where the new value for the property should be written (block 407). The IFW configuration software tool 100 may then write the new value specified by the input into the memory buffer at the offset corresponding to the property (block 409). The IFW configuration software tool 100 may then invoke another software routine (e.g., another SMI handler) implemented by the initialization firmware with the address of the modified memory buffer, and the invoked software routine may execute to change the initialization firmware settings to the new settings specified by the modified memory buffer (block 411).

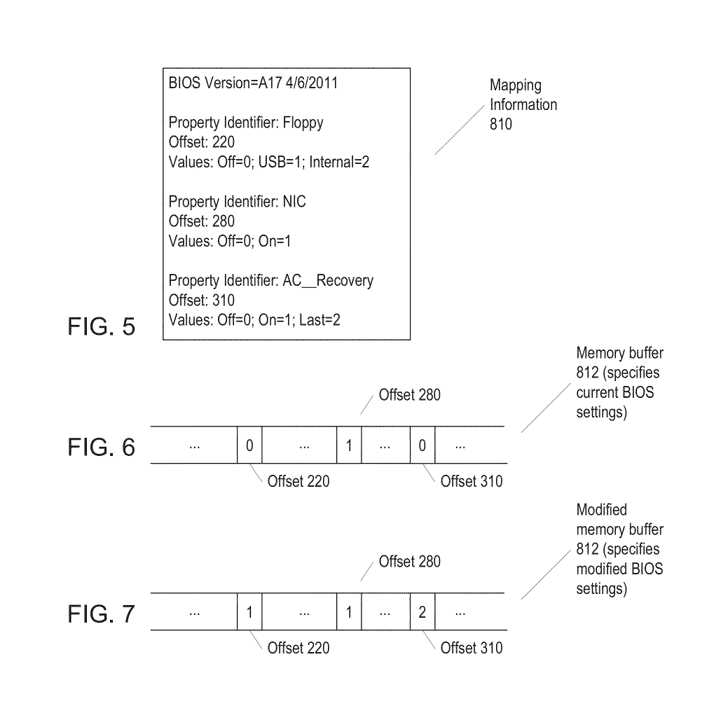

The mapping information of the IFW configuration software tool 100 may be used to map the initialization firmware properties specified by the input to the corresponding offsets in the memory buffer. FIG. 5 illustrates a portion of mapping information 810 for a particular version of BIOS firmware according to one embodiment. The illustrated portion includes mapping information for the three properties mentioned above relating to floppy drives, the NIC card, and AC power recovery. The property that controls the configuration of the floppy drives has an identifier of “Floppy” and corresponds to offset 220 of the memory buffer (e.g., 220 bytes after the first byte of the memory buffer). The possible values for this property have the identifiers “Off”, “USB” and “Internal”, which are mapped to the values 0, 1, and 2, respectively. The property that controls the configuration of the NIC has an identifier of “NIC” and corresponds to offset 280 of the memory buffer (e.g., 280 bytes after the first byte of the memory buffer). The possible values for this property have the identifiers “Off” and “On”, which are mapped to the values 0 and 1, respectively. The property that controls how the computer system responds when AC power is restored has an identifier of “AC_Recovery” and corresponds to offset 310 of the memory buffer (e.g., 310 bytes after the first byte of the memory buffer). The possible values for this property have the identifiers “Off”, “On” and “Last”, which are mapped to the values 0, 1, and 2, respectively.

FIG. 6 illustrates portions of a memory buffer 812 in which the current BIOS settings are stored, e.g., after the first SMI handler of the BIOS has been invoked to store the current BIOS settings in the memory buffer. As shown, the value 0 is stored at offset 220, indicating that the “Floppy” property is currently set to the “Off” value. Similarly, the value 1 is stored at offset 280, indicating that the NIC property is currently set to the “On” value, and the value 0 is stored at offset 310, indicating that the AC_Recovery property is currently set to the “Off” value.

FIG. 7 illustrates the same portions of the memory buffer 812 in which the new BIOS settings requested by the input are stored. For example, the input may include text such as “Floppy=USB; AC_Recovery=Last”. The IFW configuration software tool 100 may use the mapping information 810 to map the property identifier “Floppy” to the offset 220 and map the value identifier “USB” to the value 1. The IFW configuration software tool 100 may then write the value 1 into the memory buffer 812 at offset 220 to replace the original value 0. Similarly, the IFW configuration software tool 100 may map the property identifier “AC_Recovery” to the offset 310 and map the value identifier “Last” to the value 2, and may then write the value 2 into the memory buffer 812 at offset 310 to replace the original value 0. Once the new values for all the properties specified by the input have been written into the memory buffer at the appropriate offsets, the IFW configuration software tool 100 may pass the address of the modified memory buffer 812 to an SMI handler implemented by the BIOS program code 162. The SMI handler may execute to modify the BIOS settings 163 stored in the non-volatile memory 161 to set the BIOS settings 163 to the values specified by the modified memory buffer 812.

As noted above, the IFW configuration software tool 100 may be configured to operate on different initialization firmware versions. The memory buffer used to specify the initialization firmware settings may be formatted differently for different initialization firmware versions, e.g., such that the same initialization firmware property corresponds to different memory buffer offsets for different initialization firmware versions. The mapping information 810 may include mapping information for each initialization firmware version supported by the IFW configuration software tool 100. Thus, the IFW configuration software tool 100 may determine the particular initialization firmware version of the computer system 82 and access the mapping information corresponding to this initialization firmware version to determine the appropriate memory buffer offsets and values to use to implement the changes requested by the input. The portion of mapping information 810 illustrated in FIG. 5 is the mapping information for a particular BIOS version having a version name of “A17 Apr. 6, 2011”.

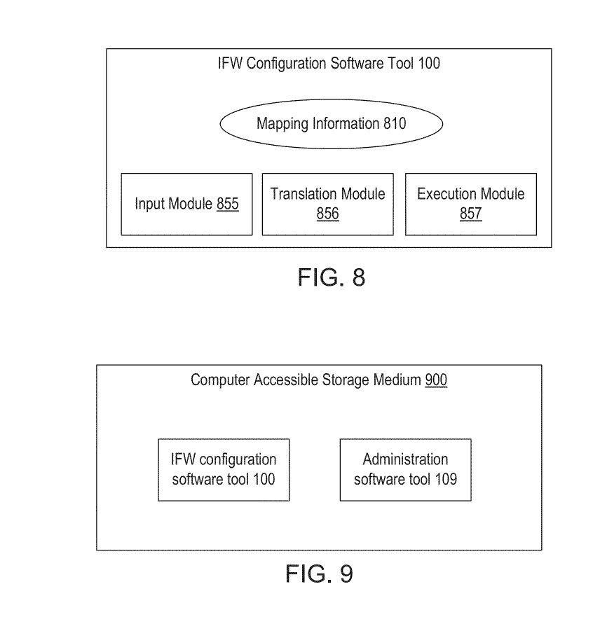

FIG. 8 illustrates an architecture of the IFW configuration software tool 100 according to some embodiments. The IFW configuration software tool 100 may include the mapping information 810, which may be stored on the hard drive 182 or other storage device of the computer system 82 and read into the main memory 166 during the execution of the IFW configuration software tool 100. The mapping information 810 may be stored in one or more files or databases, and may be formatted in various ways. In some embodiments the mapping information 810 may be formatted as an XML document or other markup language document.

The IFW configuration software tool 100 may also include an input module 855, a translation module 856, and an execution module 857. The input module 855 may execute to receive the input specifying the desired changes to the initialization firmware settings. The translation module 856 may execute to generate initialization firmware configuration information based on the received input. The execution module 857 may execute to apply the initialization firmware configuration information generated by the translation module 856 to the initialization firmware information stored in the non-volatile memory 161.

In some embodiments the translation module 856 may generate the initialization firmware configuration information by generating a memory buffer such as described above, and the execution module 857 may apply the initialization firmware configuration information by invoking an SMI handler or other software routine of the initialization firmware with the address of the memory buffer. In other embodiments the IFW configuration software tool 100 may not invoke an SMI handler or other software routine of the initialization firmware, but may instead interface directly with the non-volatile memory 161 to change the stored settings of the initialization firmware. For example, in some embodiments the translation module 856 may generate a set of set of I/O (input/output) operations to perform on the non-volatile memory 161. The execution module 857 may then perform each I/O operation in the generated set of I/O operations. The I/O operations may operate to modify data stored at particular locations in the non-volatile memory 161 to implement the changes specified by the input. Examples of I/O operations that may be performed include I/O port accesses, PCI bus accesses, and memory accesses.

If the IFW configuration software tool 100 performs I/O operations that interface directly with the non-volatile memory 161 to change the BIOS settings 163 then the IFW configuration software tool 100 may also need to compute one or more checksums from the modified BIOS settings and store the checksums in the non-volatile memory 161. The checksums may enable the BIOS software to check whether the non-volatile memory 161 contains the expected data.

Turning now to FIG. 9, a block diagram of a computer accessible storage medium 900 is shown. The computer accessible storage medium 900 may store program instructions executable by one or more processors to implement various functions described above, such as program instructions associated with the IFW configuration software tool 100. Generally, the computer accessible storage medium 900 may store any set of instructions which, when executed, implement a portion or all of the functions described above for reconfiguring the initialization firmware of the computer system 82. In some embodiments the computer accessible storage medium 900 may store program instructions of an administration software tool 109 which is executable by one or more processors to provide input to the IFW configuration software tool 100 requesting particular changes to the initialization firmware of the computer system 82. For example, the administration software tool 109 may execute on a remote administration computer and provide the input to the IFW configuration software tool 100 executing on the computer system 82 via a network.

A computer accessible storage medium may include any storage media accessible by one or more computers during use to provide instructions and/or data to the computer(s). For example, a computer accessible storage medium may include storage media such as magnetic or optical media, e.g., one or more disks (fixed or removable), tapes, CD-ROMs, DVD-ROMs, CD-Rs, CD-RWs, DVD-Rs, DVD-RWs, or Blu-Ray disks. Storage media may further include volatile or non-volatile memory media such as RAM (e.g. synchronous dynamic RAM (SDRAM), Rambus DRAM (RDRAM), static RAM (SRAM), etc.), ROM, Flash memory, non-volatile memory (e.g. Flash memory) accessible via a peripheral interface such as the Universal Serial Bus (USB) interface, a flash memory interface (FMI), a serial peripheral interface (SPI), etc. Storage media may include microelectromechanical systems (MEMS), as well as storage media accessible via a communication medium such as a network and/or a wireless link. A carrier medium may include computer accessible storage media as well as transmission media such as wired or wireless transmission.

Numerous variations and modifications will become apparent to those skilled in the art once the above disclosure is fully appreciated. It is intended that the following claims be interpreted to embrace all such variations and modifications.

What is claimed is:

1. A computer-accessible storage medium storing program instructions executable by one or more processors to:
following completion of a boot procedure of a computer system, receive an input request to change a configuration of initialization firmware of the computer system, wherein the initialization firmware includes information stored in a non-volatile memory of the computer system; and
automatically change the configuration of the initialization firmware in response to the input request, wherein said automatically changing the configuration of the initialization firmware includes automatically changing the information stored in the non-volatile memory after completion of the boot procedure and while an operating system of the computer system is executing.

2. The computer-accessible storage medium of claim 1,
wherein the initialization firmware includes one or more of:
BIOS (Basic Input/Output System) firmware; or
UEFI (Unified Extensible Firmware Interface) firmware.

3. The computer-accessible storage medium of claim 1,
wherein the input request indicates one or more properties of the initialization firmware and a corresponding value for each of the one or more properties;
wherein in automatically changing the configuration of the initialization firmware, the program instructions are executable by the one or more processors to configure each of the one or more properties based on the corresponding value.

4. The computer-accessible storage medium of claim 3, wherein the program instructions are further executable by the one or more processors to:
automatically generate configuration information based on the input; and
apply the configuration information to the initialization firmware, wherein applying the configuration information to the initialization firmware configures each of the one or more properties based on the corresponding value.

5. The computer-accessible storage medium of claim 4,
wherein in generating the configuration information, the program instructions are executable by the one or more processors to store information in a memory buffer, wherein each of the one or more properties corresponds to a memory location at a respective offset of the memory buffer, wherein in storing the information in the memory buffer, the program instructions are executable by the one or more processors to set the memory location corresponding to each respective property to the value corresponding to the property.

6. The computer-accessible storage medium of claim 5,
wherein in applying the configuration information to the initialization firmware, the program instructions are executable by the one or more processors to pass the memory buffer to a software routine implemented by the initialization firmware.

7. The computer-accessible storage medium of claim 6,
wherein the software routine implemented by the initialization firmware is a SMI (System Management Interrupt).

8. The computer-accessible storage medium of claim 4,
wherein in generating the configuration information, the program instructions are executable by the one or more processors to generate a set of I/O (input/output) operations to perform on the non-volatile memory;
wherein in applying the configuration information to the initialization firmware, the program instructions are executable by the one or more processors to perform each I/O operation in the generated set of I/O operations.

9. The computer-accessible storage medium of claim 4,
wherein the program instructions are further executable by the one or more processors to determine version information indicating a particular version of the initialization firmware of the computer system, wherein the generated configuration information is specific to the particular version of the initialization firmware.

10. The computer-accessible storage medium of claim 1,
wherein the input request indicates a first property of the initialization firmware and a first value for the first property;
wherein the program instructions are further executable by the one or more processors to:
map the first property of the initialization firmware to a first memory location at a particular offset in a memory buffer stored in RAM (random access memory) of the computer system; and
write the first value to the first memory location in the memory buffer;
wherein in automatically changing the configuration of the initialization firmware, the program instructions are executable by the one or more processors to pass the memory buffer to a software routine implemented by the initialization firmware, wherein the software routine is executable to read the first value from the first memory location in the memory buffer and configure the first property of the initialization firmware based on the first value.

11. The computer-accessible storage medium of claim 10,
wherein the software routine is executable to configure the first property of the initialization firmware based on the first value by writing the first value to a particular location in the non-volatile memory, wherein the particular location corresponds to the first property.

12. The computer-accessible storage medium of claim 10,
wherein prior to said changing the configuration of the initialization firmware, the first property of the initialization firmware is set to a second value;
wherein the program instructions are further executable by the one or more processors to:
prior to said writing the first value to the first memory location in the memory buffer, store information indicating an initial configuration of the initialization firmware in the memory buffer, wherein storing the information indicating the initial configuration of the initialization firmware includes storing the second value at the first memory location in the memory buffer, wherein said writing the first value to the first memory location replaces the second value in the memory buffer with the first value.

13. The computer-accessible storage medium of claim 1,
wherein the computer system is a first computer system;
wherein a second computer system is configured to transmit the input request to the first computer system via a network;
wherein the program instructions are executable by one or more processors of the first computer system to perform said receiving the input request and said automatically changing the configuration of the initialization firmware.

14. A system comprising:
an administration computer; and
a plurality of computers coupled to the administration computer via a network, wherein each computer of the plurality of computers includes non-volatile memory storing initialization firmware information;
wherein the administration computer is configured to transmit to each respective computer of the plurality of computers input requesting to change the initialization firmware information stored in the non-volatile memory of the respective computer;
wherein each respective computer of the plurality of computers is configured to:
receiving the input from the administration computer after the respective computer has completed a boot procedure; and
automatically change the initialization firmware information stored in the non-volatile memory of the respective computer as requested by the input, after the boot procedure has completed and while an operating system of the respective computer is executing.

15. The system of claim 14,
wherein the plurality of computers coupled to the administration computer are server computers that implement a service cloud providing computing services.

16. The system of claim 14,
wherein the plurality of computers coupled to the administration computer are computers under test in an automated testing procedure.

17. The system of claim 14,
wherein the input received by each respective computer indicates one or more properties of the initialization firmware and a corresponding value for each of the one or more properties;
wherein in automatically changing the configuration of the initialization firmware, each respective computer is configured to generate a memory buffer, wherein each of the one or more properties corresponds to a memory location at a respective offset of the memory buffer, wherein generating the memory buffer includes setting the memory location corresponding to each respective property to the value corresponding to the property.

18. A method comprising:
following completion of a boot procedure of a computer system, receiving an input request to change a configuration of initialization firmware of the computer system, wherein the initialization firmware includes information stored in a non-volatile memory of the computer system; and
automatically changing the configuration of the initialization firmware in response to the input request, wherein automatically changing the configuration of the initialization firmware includes automatically changing the information stored in the non-volatile memory after completion of the boot procedure and while an operating system of the computer system is executing.

19. The method of claim 18,
wherein the initialization firmware includes one or more of:
BIOS (Basic Input/Output System) firmware; or
UEFI (Unified Extensible Firmware Interface) firmware.

20. The method of claim 18,
wherein the input request indicates one or more properties of the initialization firmware and a corresponding value for each of the one or more properties;
wherein said automatically changing the configuration of the initialization firmware includes configuring each of the one or more properties based on the corresponding value.
